(19) United States
(12) Patent Application Publication
(10) Pub. No.: US 2013/0038296 A1
(43) Pub. Date: Feb. 14, 2013

(54) System For Storing Electric Energy

(71) Applicant: Conrad Roessel, Syrgenstein (DE)

(72) Inventor: Conrad Roessel, Syrgenstein (DE)

(21) Appl. No.: 13/582,826

(22) PCT Filed: Mar. 16, 2011
(86) PCT No.: PCT/EP2011/001281

§ 371 Date: Oct. 26, 2012

(30) Foreign Application Priority Data
Mar. 18, 2010 (DE) 10 2010 011 942.3

(51) Int. Cl. H02J 7/00; H01M 10/48

(52) U.S. Cl. 320/136; 429/61

(57) ABSTRACT

The invention relates to a system for storing electric energy, comprising a first and a second storage cell, each storage cell having an operating voltage, and a device is provided for reducing the energy content of a storage cell when a threshold voltage is exceeded or reached. The invention is characterized in that a control device which is designed to detect a parameter of the first and/or second storage cell, to identify a state of deterioration of the storage cell, and to change the threshold voltage of the first and/or the second storage cell is provided.

The invention relates to a system for storing electrical energy according to the type defined in greater detail in the preamble of Claim 1. In addition, the invention relates to a method for controlling a system designed for storing electrical energy.

Systems for storing electrical energy, and in particular for storing electrical traction energy in electric vehicles or in particular in hybrid vehicles here, are known from the general prior art. Such systems for storing electrical energy typically comprise individual storage cells, which are electrically interconnected to one another in series and/or in parallel, for example.

Fundamentally, various types of battery cells or capacitor cells are conceivable as the storage cells. Because of the comparatively high quantities of energy and in particular the high powers which occur during the storage and withdrawal of energy during use in drivetrains of vehicles and in particular utility vehicles here, preferably storage cells having a sufficient energy content and high power are used as the storage cells. For example, battery cells in lithium-ion technology or in particular storage cells in the form of very high performance double-layer capacitors can be used. These capacitors are also referred to in the technical world as super capacitors, super caps, or ultra-capacitors.

Independently of whether super capacitors or battery cells of typical type having high energy content are used, in such systems, which consist of a plurality of storage cells which can be interconnected with one another in series as a whole or also in blocks, the voltage of the individual storage cells is limited because of the construction to an upper voltage value or a threshold voltage, respectively. If this threshold voltage is exceeded, for example, during the charging of the system for storing electrical energy, the service life of the storage cells is generally drastically reduced.

Because of predefined manufacturing tolerances during the production, the individual storage cells typically deviate slightly from one another in practice (e.g., different self discharges). This has the result that a somewhat lower threshold voltage can result for individual storage cells than for other storage cells in the system in operation. Since the maximum voltage for the entire system is generally equal, however, and the maximum total voltage, in particular during charging, represents the typical activation criterion, this inevitably has the result that other storage cells, which are connected in series to the storage cells having lower threshold voltage, have a somewhat higher voltage and are then charged beyond the allowed individual maximum threshold voltage during charging procedures. Such an overvoltage results in a substantial reduction of the possible service life of the individual storage cells and therefore also of the entire system for storing electrical energy.

To remedy these problems, the general prior art essentially knows two different types of so-called cell voltage equalizers. The generally typical terminology of the “cell voltage equalizer” is misleading here, since voltages or more precisely energy contents of the individual storage cells are not equalized among one another here, but rather the cells having high voltages are reduced in their excessively high voltages. Since the total voltage of the system for storing electrical energy remains constant, via this so-called cell voltage equalizer, a cell which is decreased in its voltage can be increased in its voltage again in the course of time, so that the danger of polarity reversal is avoided.

In addition to a passive cell voltage equalizer, in which an electrical resistor is connected in parallel to each individual storage cell and therefore a continuous undesired discharge and also heating of the system occur, an active cell voltage equalizer is also used. In addition to the resistor connected in parallel to each individual storage cell, an electrical threshold value switch is connected in parallel to the storage cell and in series to the resistor. This structure, which is also referred to as the bypass electronics, only permits a current to flow when the operating voltage of the cell is above a predefined threshold voltage. As soon as the voltage of the individual storage cell falls back into a range below the predefined threshold voltage, the switch is opened and current no longer flows. Because of the fact that the electrical resistor is always deactivated via the switch when the voltage of the individual storage cells is below the predefined limiting value, undesired discharge of the overall system can also be substantially avoided. Continuous undesired heat development is also not a problem with this solution approach of the active cell voltage equalizer.

If such a system is used, for example, in cyclic operation, as typically occurs in hybrid vehicles, it may occur that the threshold voltage is only reached very briefly, under certain circumstances also not for a long time. For example, this can occur if, in the event of a strong energy withdrawal from the store, for example, in the event of strong boost operation, hardly any energy recuperation occurs simultaneously and the store is therefore no longer completely filled.

Further problems result in the practical implementation of such energy storage systems. With suitable arrangement of individual storage cells to form an overall system, different effective cooling possibilities naturally prevail for different times. For example, cooling air which has already been heated by storage cells located upstream reaches specific cells. Furthermore, because of the construction, an edge layer exists for individual storage cells, which can have a thermal advantage or disadvantage. Since multiple storage cells are normally connected in series, these cells connected in series conduct the same current and therefore also generate substantially comparable amounts of heat from power loss. Through the unavoidable differences with respect to the cooling of the individual storage cells, different temperatures result for individual storage cells. The service life of the individual storage cells is strongly dependent on their temperature in operation. As a result, storage cells having continuously higher thermal strain age more rapidly. Upon reaching the end of life of these storage cells, the entire storage system typically becomes unusable, although under certain circumstances, the overwhelming majority of storage cells, which were subjected to a lesser thermal strain considered over their service life, are still functional.

In addition to the problem of the different temperature strains of individual storage cells, for example, because of different structural situations, the problem exists that the values of individual storage cells are subjected to production-related scattering. For example, a variation of the internal resistance between the individual storage cells causes a variation of the intrinsic temperature, which is more or less installed from the beginning, of various storage cells with identical current and identical installation situation. This could be avoided by a strict selection of the internal resistance values within a store. However, this represents a very complex procedure in the event of a selection of several hundred cells per storage system.

In addition, besides the scattering of production-related parameters, further production-related differences exist between the individual storage cells, which can occur, for example, through slight contaminants of different strengths from cell to cell, for example, residual moisture and traces of associated materials, which only result in varying worsening of individual storage cells in the course of time. This cannot be recognized or compensated for by a selection of the storage cells after the production or before the installation.

It is an object of the present invention to specify a system for storing electrical energy, which allows efficient storage and withdrawal of energy and offers an improved overall service life of the system.

This object is achieved by a system and a method having the features of the independent claims. Further embodiments of the invention are specified in the dependent claims.

The invention therefore provides a system for storing electrical energy, which comprises at least one first storage cell and one second storage cell. Such a system will typically have a plurality of storage cells, for example, in the range of hundreds of storage cells. A device for reducing the energy content of the storage cells is assigned to the storage cells. If an operating voltage of a storage cell reaches or exceeds a specific threshold voltage, energy is withdrawn from the storage cell by this device. This can be performed by a current flow via a consumer connected in parallel.

The system is characterized according to the invention in that a control unit is provided. The control unit detects one or more parameters of a single storage cell or a plurality of storage cells. The control unit derives information about the aging state of the one or more storage cells from the detection of the one or more parameters. On the basis of this information, the control unit sets the threshold voltage of the affected storage cell or storage cells.

It is therefore a basic idea of the present invention to recognize an aging state of the storage cell which is influenced by external or internal influences and, for controlled aging of the storage cell, to control a parameter which influences the aging, specifically the maximum operating voltage in the form of the threshold voltage, in accordance with the recognized aging state of the storage cell.

According to an advantageous embodiment of the invention, the internal resistance of a storage cell or the capacitance of a storage cell can be provided as the parameter which characterizes the aging of the storage cell. These or further parameters which characterize the aging can be taken into consideration solely or in combination during an adaptation of the threshold voltage of a storage cell. The internal resistance of a storage cell receives particular significance in this case. In applications for the storage system in which high energy withdrawals occur regularly because of high power demands, an increased internal resistance is self-reinforcing to a pronounced extent. The waste heat of a storage cell rises with an aging-related increase of the internal resistance of this storage cell. After the storage cell already has a higher temperature because of the high internal resistance, it heats up still more, and thus ages more rapidly, which in turn is expressed in the increase of the internal resistance. A self-reinforcing aging scenario thus results, against which the present invention provides a remedy in that, through a reduction of the threshold voltage of a cell affected in this manner, the self-reinforcing aging can be limited in relation to the adjacent cells. Control or regulation, respectively, is therefore conceivable in such a manner that an increase of the internal resistance by a specific value is compensated for by a reduction of the maximum operating voltage of the cell by a corresponding value. An assignment table between internal resistance and threshold voltage, a corresponding functional relationship, or a regulation of the threshold voltage on the basis of a suitable control variable can optionally be produced in this case.

A refinement according to the invention of the invention provides that the control unit is also configured so that a reduction of the threshold voltage of the first storage cell is at least partially compensated for by the increase of the threshold voltage of the second storage cell. This refinement allows, in particular in the event of a large number of storage cells, overall optimized and controlled aging of the entire storage system with uniform total voltage or available storage capacity, respectively. Therefore, for example, one or more particularly strongly aging storage cells can be decelerated in the aging, for example, in that their threshold voltage is decreased. This voltage loss can be compensated for, for example, in the same storage cell chain connected in series by a slight increase of the threshold voltage in the event of a substantially larger number of less strongly aging storage cells. Overall, uniform aging of all storage cells therefore occurs and thus also optimization of the service life of the storage system.

Alternatively, of course, only the threshold voltage of individual cells can be reduced and a reduced total voltage of the system can be accepted, in order to achieve a maximum possible service life of the entire system.

In an advantageous embodiment of the invention, the control unit is configured so that the aging state of the first storage cell is ascertained in relation to the aging state of the second storage cell. The direct comparison of the aging states of two storage cells offers the possibility in a simple manner of optimizing the overall aging state of the storage system. A further embodiment provides that the aging state of the first storage cell is ascertained in relation to a mean value of a plurality of storage cells. It can be provided, for example, that the threshold voltage is set in such a manner that the first storage cell equalizes its aging state to the mean value of the plurality of storage cells within a specific period of time. A further embodiment provides that the aging state of the first storage cell is ascertained in relation to an initial value of the aging. This can be the first ascertained parameter set of the storage cell upon installation or production, for example. A further reference value with respect to the aging can be a last ascertained value. Therefore, the instantaneous aging curve of the storage cell can be directly inferred. Of course, a combination of all or some of the mentioned reference variables is also possible. Thus, for example, particularly precise estimation of the development of the aging state of the first storage cell can be achieved from the first measured initial parameter set and the last measured values or a series of last measured values. The aging state thus ascertained can then be led up to the desired aging state within a period of time.

In this context, it is particularly advantageous that the control unit is configured so that it detects a time curve of the parameters of the storage cell. The time curve of the aging state of a storage cell allows monitoring of the aging curves of a cell, on the one hand, as well as particularly precise prediction about the future aging behavior and the present aging state.

According to one embodiment of the invention, the control unit is designed so that the threshold voltage is set as a function of the aging state of a storage cell. It can be provided in particular that in the event of a comparatively good aging state, the threshold voltage of the storage cell is increased in order to thus make its better aging state usable for the provision of a higher operating voltage. Vice versa, in the event of a comparably progressed, i.e., poor aging state, the strain of the storage cell can be reduced by decreasing the threshold voltage and the aging state of the storage cell can thus be approximated to the comparison standard.

The object is also achieved according to the invention by a method for controlling a system designed for storing electrical energy. The system comprises multiple storage cells, each having an operating voltage and a device for limiting the operating voltage/reducing the energy content of the storage cell. The method comprises the steps of detecting the aging state of the storage cell and setting the threshold voltage of storage cells in accordance with the aging state.

In particular, it can be provided in the method that, after a time interval, the aging state of storage cells is detected again.

A further particularly advantageous embodiment of the idea according to the invention provides a use of the storage system in a motor vehicle. In this context, uniform aging of the storage cells or in particular a uniform internal resistance of all storage cells, respectively, is advantageous. In the case of an accident of the motor vehicle, mechanical damage can result in a short-circuit of the entire store, for example, damage in the connecting lines to the electric drive. If the cells have different internal resistances because of different aging, for example, the cells having high internal resistances heat up substantially more strongly in the event of a short-circuit than cells having low internal resistance. The energy content of the less strongly aged cells thus heats up the cells having high internal resistances. The cells having the high internal resistances can thus be destroyed under certain circumstances, which can result in escape of materials, which are typically harmful to health, and destruction of the entire storage system. A store having uniformly distributed internal resistances, in contrast, has a significantly reduced risk in this context and can still remain usable under certain circumstances.

Further advantageous embodiments of the system and the method according to the invention result from the exemplary embodiment, which is described in greater detail hereafter on the basis of the figures.

In the figures:

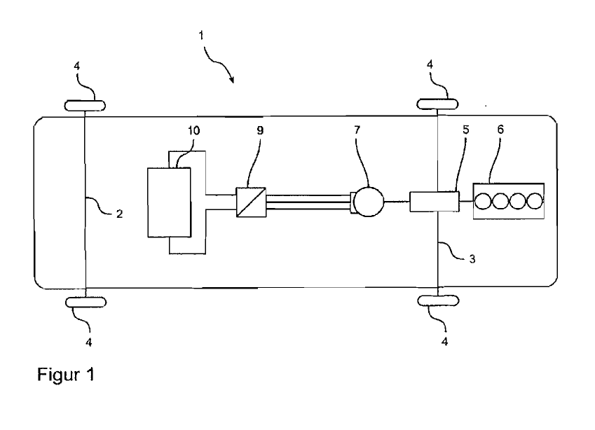

FIG. 1 shows an exemplary construction of a hybrid vehicle;

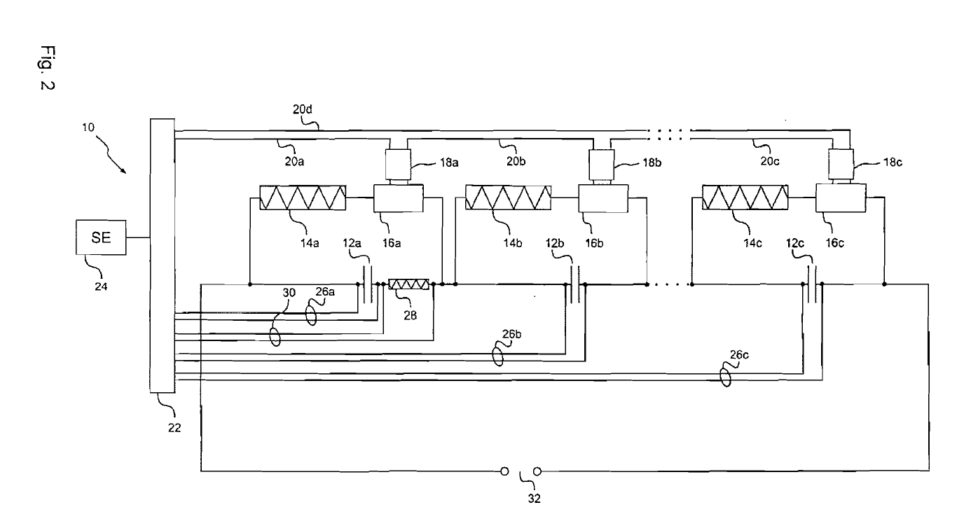

FIG. 2 shows a schematic view of an embodiment of a system for storing electrical energy.

FIG. 1 shows an exemplary hybrid vehicle 1. It has two axles 2, 3, each having two wheels 4 indicated as examples. The axle 3 is to be a driven axle of the vehicle 1, while the axle 2 merely co-rotates in a way known per se. A transmission 5 for driving the axle 3 is shown as an example, which receives the power from an internal combustion engine 6 and an electrical machine 7 and conducts it into the region of the driven axle 3. In the drive case, the electrical machine 7 can conduct drive power into the region of the driven axle 3 alone or in addition to the drive power of the internal combustion engine 6 and can therefore drive the vehicle 1 or assist the drive of the vehicle 1, respectively. In addition, during deceleration of the vehicle 1, the electrical machine 7 can be operated as a generator, in order to thus reclaim power arising during braking and store it appropriately. In order to be able to provide a sufficient energy content in the event of use in a city bus as a vehicle 1, for example, even for braking procedures from higher velocities, which will certainly be at most approximately 70 km/h in the case of the city bus, in this case a system 10 for storing electrical energy must be provided, which has an energy content in the magnitude of, e.g., 350 to 700 Wh. Therefore, energies which can arise during an approximately 10 second long braking procedure from such a velocity, for example, may also be converted via the electrical machine 7, which will typically have a magnitude of approximately 150 kW, and stored in the system 10.

To activate the electrical machine 7 and to charge and discharge the system 10 for storing electrical energy, the structure according to FIG. 1 has an inverter 9, which is implemented in a way known per se having an integrated control unit for the energy management. Via the inverter 9 having the integrated control unit, the energy flow between the electrical machine 7 and the system 10 for storing the electrical energy is coordinated appropriately. The control unit ensures that during braking in the range, the power arising in the electrical machine 7, which is then driven as a generator, is stored as much as possible in the system 10 for storing the electrical energy, a predefined upper voltage limit of the system 10 generally not being able to be exceeded. In the drive case, the control unit in the inverter 9 coordinates the withdrawal of electrical energy from the system 10, in order to drive the electrical machine 7 by means of this withdrawn power in this reversed case. In addition to the hybrid vehicle 1 described here, which can be a city bus, for example, a comparable structure would also be conceivable in a solely electric vehicle, of course.

FIG. 2 schematically shows a detail of a system 10 according to the invention for storing electrical energy. In principle, various types of the system 10 are conceivable. Such a system is typically constructed so that a plurality of storage cells 12 are interconnected in series in the system 10. The storage cells 12 can be battery cells and/or super capacitors, or also an arbitrary combination thereof. For the exemplary embodiment shown here, the storage cells 12 are all to be implemented as super capacitors, i.e., as double-layer capacitors, which are to be used in a system 10 for storing electrical energy in the vehicle 1 equipped with the hybrid drive. The structure can preferably be used in a utility vehicle, for example, an omnibus for city/short-range traffic. In this case, due to frequent starting and braking maneuvers in conjunction with a very high vehicle mass, a particularly high efficiency of the storage of the electrical energy by the super capacitors is achieved, since comparatively high electrical powers flow. Since super capacitors as storage cells 12 have a very much lower internal resistance than, for example, battery cells, they are preferable for the exemplary embodiment described in greater detail here.

As already mentioned, the storage cells 12 can be recognized in FIG. 2. Only three storage cells 12a, 12b, 12c, which are connected in series, are shown. In the case of the above-mentioned exemplary embodiment and a corresponding electrical drive power of approximately 100 to 200 kW, for example, 120 kW, this would be a total of approximately 150 to 250 storage cells 12 in a realistic structure. If these storage cells are implemented as super capacitors having a present upper voltage limit of approximately 2.7 V per super capacitor and a capacitance of 3000 F, a realistic application would be provided for the hybrid drive of a city omnibus.

As shown in FIG. 2, each of the storage cells 12a, 12b, 12c has an electrical consumer in the form of an ohmic resistor 14a, 14b, 14c connected in parallel to the respective storage cell 12a, 12b, 12c. This resistor is connected in series to a switching element 16a, 16b, 16c in parallel to each of the storage cells 12a, 12b, 12c. The switch 16a, 16b, 16c is implemented as a threshold value switch and has a control input 18a, 18b, 18c. The control inputs 18a-18c are connected via lines 20a-20d to a CAN bus system 22, for example. A control unit 24 is also connected to the CAN bus system 22, receives data of the individual storage cells 12a-12c, and transmits corresponding information to the control inputs 18a-18c of the threshold value switches 16a-16c. For example, the capacitance of the individual storage cells 12a-12c is made available to the control unit 24 via lines 26a-26c and the CAN bus system 22. A current measuring device 28 (for example, a measuring resistor) connected in series to the storage cells 12a-12c allows, via lines 30, which are connected to the CAN bus system 22, the ascertainment of the current flow through the storage cells 12a-12c and therefore also the ascertainment of the internal resistance.

The control unit 24 ascertains, for each cell 12a, 12b, 12c, their performance data such as the internal resistance and the capacitance and specifies an individual maximum operating voltage to the cells. This takes into consideration the current status of the storage cell. Cells having comparatively poor performance data are assigned a lower voltage, for example, 2.45 V instead of 2.5 V, in order to thus slow their aging. Cells having better performance data can be assigned a higher maximum operating voltage, for example, 2.55 V instead of 2.5 V, in order to accelerate their aging. A uniform voltage level can thus always be ensured for the connected hybrid drive, which is connected at the position 32, if this is necessary.

Through this control, imponderables with respect to the performance capability of individual storage cells, which result from production tolerances, are compensated for adaptively and continuously. Early failure of the overall storage system 10 due to individual strongly aged storage cells is prevented. As a further positive effect, the mean temperature of the storage system is decreased, since the waste heat arises uniformly distributed on all storage cells and therefore more surface area can be used for cooling. A maximum usage duration or total service life of the storage system 10 and a maximum performance over the service life are achieved.

In case of an accident, a short-circuit of the entire store, e.g., in the connection lines to the electric drive, can occur due to mechanical damage. If the cells have different internal resistances due to different aging states, the cells having high internal resistances heat up substantially more strongly than the cells having low internal resistance—the energy content of the less strongly aged cells heats up the cells having the high internal resistances. The cells having the high internal resistances can thus burst under certain circumstances, which can result in an escape of materials, which are typically harmful to health, and destruction of the storage system. A store having uniformly distributed internal resistances can still remain usable, in contrast.

The different maximum operating voltages or threshold voltages, respectively, are implemented by specifications of the control unit 24 to the control inputs 18a-18c of the threshold value switches 16a-16c of the individual storage cells 12a-12c via the CAN bus system 22.

The individual specified values can be calculated, for example, from differences with respect to the internal resistances and the capacitance between individual cells or a mean value of all cells. Instead of the mean value of all cells, an initial stored value or a last measured value can also be used.

The individual measured values are either used per se, evaluated with a correction factor which possibly takes into consideration the construction or a cooling air stream, and/or linked to one another to form a measure for the newly changed cell voltages of the storage cells 12a-12c.

In addition, changes can be recorded or considered over an observation interval. For example, if differences in the internal resistances or the capacitances do not change in spite of a preceding adaptation of the threshold voltage, the specifications which are to level out these differences can be changed further. For example, the threshold voltages can be decreased further for storage cells having weak performance data and can be increased further for storage cells having lesser aging. The specific specified values can be ascertained from model calculations or experiments.

1-10. (canceled)

11. A system for storing electrical energy, comprising:
a first storage cell and a second storage cell, each storage cell having an operating voltage, a device being provided for reducing the energy content of a storage cell upon exceeding or reaching a threshold voltage,
characterized in that a control unit is provided, which is adapted for detecting a parameter of the first storage cell and/or the second storage cell, recognizing an aging state of the storage cell, and changing the threshold voltage of the first and/or the second storage cell so that a reduction of the threshold voltage of the first storage cell can be at least partially compensated for by an increase of the threshold voltage of the second storage cell.

12. The system according to claim 11, characterized in that the parameter is an internal resistance and/or a capacitance.

13. The system according to claim 11, characterized in that the device for reducing the energy content of a storage cell comprises a consumer and a switching element and is arranged in parallel to a storage cell.

14. The system according to claim 12, characterized in that the device for reducing the energy content of a storage cell comprises a consumer and a switching element and is arranged in parallel to a storage cell.

15. The system according to claim 11, characterized in that the switching unit is also configured so that the aging state of the first storage cell is ascertained in relation to the aging state of the second storage cell and/or in relation to a mean value of a plurality of storage cells and/or in relation to an initial value and/or in relation to a last measured value.

16. The system according to claim 12, characterized in that the switching unit is also configured so that the aging state of the first storage cell is ascertained in relation to the aging state of the second storage cell and/or in relation to a mean value of a plurality of storage cells and/or in relation to an initial value and/or in relation to a last measured value.

17. The system according to claim 13, characterized in that the switching unit is also configured so that the aging state of the first storage cell is ascertained in relation to the aging state of the second storage cell and/or in relation to a mean value of a plurality of storage cells and/or in relation to an initial value and/or in relation to a last measured value.

18. The system according to claim 14, characterized in that the switching unit is also configured so that the aging state of the first storage cell is ascertained in relation to the aging state of the second storage cell and/or in relation to a mean value of a plurality of storage cells and/or in relation to an initial value and/or in relation to a last measured value.

19. The system according to claim 11, characterized in that the control unit is configured so that it detects a time curve of the parameters of the storage cells.

20. The system according to claim 12, characterized in that the control unit is configured so that it detects a time curve of the parameters of the storage cells.

21. The system according to claim 13, characterized in that the control unit is configured so that it detects a time curve of the parameters of the storage cells.

22. The system according to claim 14, characterized in that the control unit is configured so that it detects a time curve of the parameters of the storage cells.

23. The system according to claim 15, characterized in that the control unit is configured so that it detects a time curve of the parameters of the storage cells.

24. The system according to claim 16, characterized in that the control unit is configured so that it detects a time curve of the parameters of the storage cells.

25. The system according to claim 17, characterized in that the control unit is configured so that it detects a time curve of the parameters of the storage cells.

26. The system according to claim 18, characterized in that the control unit is configured so that it detects a time curve of the parameters of the storage cells.

27. The system according to claim 11, characterized in that the control unit is designed so that the threshold voltage of a storage cell is set as a function of the aging state of the storage cell.

28. The system according to claim 11, characterized in that, in the event of a poor aging state of a storage cell, the threshold value of the storage cell is decreased and/or, in the event of a good aging state of a storage cell, the threshold value of the storage cell is increased.

29. A method for controlling a system designed for storing electrical energy, wherein the system has multiple storage cells each having an operating voltage and a device for reducing the energy content of the storage cells, having the steps of detecting the aging state of storage cells and setting the threshold voltage of storage cells in accordance with the aging state.

30. A use of a system according to claim 11 in a motor vehicle.
